(19) United States
(12) Patent Application Publication
(10) Pub. No.: US 2026/0238899 A1
(43) Pub. Date: Aug. 13, 2026

(54) IMAGE SENSOR CIRCUIT, STORAGE CIRCUIT, AND METHOD CAPABLE OF DECREASING CIRCUIT COSTS AND PROVIDING HIGH DYNAMIC RANGE BY CHANGING REFERENCE LEVEL OF ITS SENSOR CIRCUIT

(71) Applicant: PixArt Imaging Inc., Hsin-Chu City (TW)

(72) Inventors: Kuan Tang, Hsin-Chu City (TW); Yi-Cheng Chiu, Hsin-Chu City (TW); Jui-Te Chiu, Hsin-Chu City (TW)

(73) Assignee: PixArt Imaging Inc., Hsin-Chu City (TW)

(21) Appl. No.: 19/048,958

(22) Filed: Feb. 9, 2025

(51) Int. Cl. H04N 25/771; H04N 25/78

(52) U.S. Cl. CPC H04N 25/771; H04N 25/78

(57) ABSTRACT

A storage circuit of an image sensor circuit includes a transfer gate switch transistor, a floating diffusion node, a signal storage circuit, and a reset storage circuit. The reference level, coupled to the transfer gate switch transistor, changes between a low level and a high level. When the reference level changes from the high level into the low level, a voltage level at the second floating diffusion node is reset, and then the voltage level at the second floating diffusion node is increased in response to a charge signal at a first floating diffusion node of a sensor circuit of the image sensor circuit when the reference level changes from the low level into the high level.

### BACKGROUND OF THE INVENTION

### 1. Field of the Invention

The invention relates to an image sensing mechanism, and more particularly to an image sensor circuit, a corresponding storage circuit, and a corresponding method.

### 2. Description of the Prior Art

Generally speaking, a conventional image sensor device inevitably needs to use a bias current source and a gate select transistor to transfer and dump the signal charges from a first floating diffusion node in a sensor circuit of the conventional image sensor device into a second floating diffusion node which is coupled to a readout circuit of the conventional image sensor device. Implementing this conventional circuit undoubtedly incurs significantly higher costs. Further, the conventional image sensor device cannot provide a function of high dynamic range for signal charges.

### SUMMARY OF THE INVENTION

Therefore one of the objectives of the invention is to provide an image sensor circuit and a corresponding storage circuit, to solve the above mentioned problems.

According to embodiments of the invention, a storage circuit of an image sensor circuit is disclosed. The storage circuit is disposed between a sensor circuit of the image sensor circuit and a readout circuit of the image sensor circuit. The storage circuit comprises a transfer gate switch transistor, a second floating diffusion node, signal storage circuit, and a reset storage circuit. The transfer gate switch transistor has a first node coupled to a first floating diffusion node and a second node coupled to the second floating diffusion node. The second floating diffusion node is to be read by the readout circuit. The signal storage circuit is coupled between the second floating diffusion node and a ground level. The reset storage circuit is coupled between the second floating diffusion node and the ground level. The reference level changes between a low level and a high level. When the reference level changes from the high level into the low level, a voltage level at the second floating diffusion node is reset, and then the voltage level at the second floating diffusion node is increased in response to a charge signal at the first floating diffusion node when the reference level changes from the low level into the high level.

According to embodiments of the invention, a method of an image sensor circuit is disclosed. The image sensor circuit's storage circuit is disposed between a sensor circuit of the image sensor circuit and a readout circuit of the image sensor circuit. The method comprises: providing a transfer gate switch transistor, having a first node coupled to a first floating diffusion node and a second node coupled to a second floating diffusion node; providing the second floating diffusion node, to be read by the readout circuit; providing a signal storage circuit, coupled between the second floating diffusion node and a ground level; providing a reset storage circuit, coupled between the second floating diffusion node and the ground level; changing the reference level between a low level and a high level; when the reference level changes from the high level into the low level, resetting a voltage level at the second floating diffusion node; and increasing the voltage level at the second floating diffusion node in response to a charge signal at the first floating diffusion node when the reference level changes from the low level into the high level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an image sensor circuit according to an embodiment of the invention.

FIG. 2 is a diagram of an image sensing device including multiple image sensor circuits of FIG. 1 according to an embodiment of the invention.

FIG. 3 is a diagram showing the waveforms of the corresponding control signals and the dump operation (e.g. global dump) and readout operation (e.g. row readout) of the image sensor circuit as shown in FIG. 1 according to an embodiment of the invention.

FIG. 4 is a diagram showing the waveforms of the corresponding control signals and the dump operation (e.g. global dump) and readout operation (e.g. row readout) of the image sensor circuit as shown in FIG. 1 according to another different embodiment of the invention.

FIG. 5 is a diagram of an image sensor circuit according to another embodiment of the invention.

FIG. 6 is a diagram showing the waveforms of the corresponding control signals and the dump operation (e.g. global dump) and readout operation (e.g. row readout) of the image sensor circuit as shown in FIG. 5 according to an embodiment of the invention.

FIG. 7 is a diagram of an image sensor circuit according to another embodiment of the invention.

FIG. 8 is a diagram showing the waveforms of the corresponding control signals and the dump operation (e.g. global dump) and readout operation (e.g. row readout) of the image sensor circuit as shown in FIG. 7 according to another embodiment of the invention.

### DETAILED DESCRIPTION

The invention aims at providing a technical solution of an image sensor circuit and a corresponding storage circuit, so as to decrease circuit costs (e.g. saving the costs of a bias current source and a gate select transistor) and provide a high dynamic range for pixel charges.

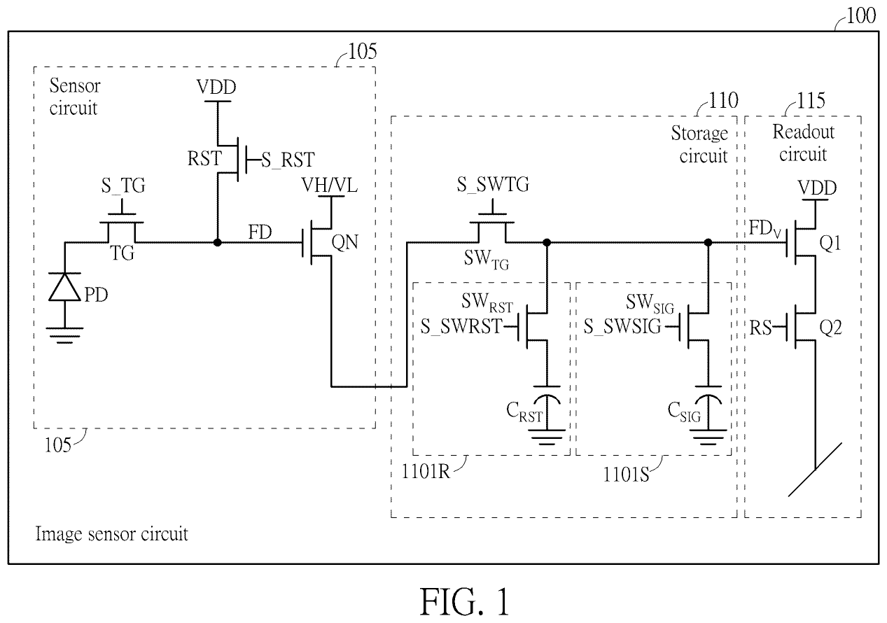

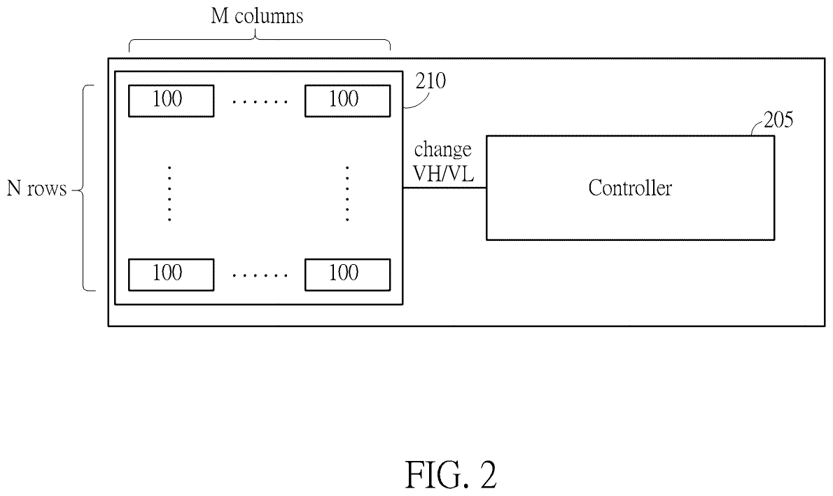

Refer to FIG. 1 in conjunction with FIG. 2. FIG. 1 is a diagram of an image sensor circuit 100 according to an embodiment of the invention. FIG. 2 is a diagram of an image sensing device 200 including multiple image sensor circuits 100 of FIG. 1 according to an embodiment of the invention. The image sensor circuit 100 comprises a sensor circuit 105, a storage circuit 110, and a readout circuit 115. For example, the image sensor circuit 100 is a pixel sensing circuit which is used as an image sensing pixel to sense and generate a pixel image signal and a pixel reset charge signal so as to a sensed pixel value. The image sensing device 200 comprises a controller 205 and an image sensing device 210 including the multiple image sensor circuits 100 disposed and arranged in N rows and M columns (but not limited), and the controller 205 is used to control the image sensor circuits 100 to generate pixel images to form and generate an image frame.

In FIG. 1, the sensor circuit 105 comprises a photodiode PD, a first floating diffusion node FD, a transfer gate transistor TG, a reset transistor RST, and a specific transistor QN. The storage circuit 110 is coupled to the sensor circuit 105 and readout circuit 115, and is disposed between the sensor circuit 105 and readout circuit 115. The storage circuit 110 comprises a transfer gate switch transistor SW_{TG}, a second floating diffusion node FDv, a signal storage circuit 1101S, and a reset storage circuit 1101R. The readout circuit 115 comprises a first readout transistor Q1 (which is used as a source flower transistor) and a second readout transistor Q2.

The photodiode PD is a light-sensitive circuit element that generates electron-hole pairs to create and generate a charge signal which is proportional to the light intensity that it receives (or senses).

The transfer gate transistor TG, coupled between the photodiode PD and first floating diffusion node FD, is controlled by a transfer gate control signal S_TG (e.g. a voltage signal) which can be generated from the controller 205 and it is used to transfer the charge signal from the photodiode PD into the first floating diffusion node FD when the transfer gate transistor TG is turned on by the transfer gate control signal S_TG. Thus, the transferred charge signal can be collected in the first floating diffusion node FD, and is then buffered in the storage circuit 110 and is then read out by the readout circuit 115. After the charge signal is transferred, the transfer gate transistor TG can be turned off and the first floating diffusion node FD is reset to prepare for the next charge transfer cycle.

The reset transistor RST, coupled between the supply voltage level VDD and first floating diffusion node FD, is controlled by a reset control signal S_RST sent from the controller 205 and is used to perform an initialization by resetting the photodiode PD to a known state before capturing new light charge data, e.g. discharging the photodiode PD to a reset voltage.

The specific transistor QN has a control node coupled to the first floating diffusion node FD, a first node (e.g. its source node) coupled to the transfer gate switch transistor SW_{TG} of the storage circuit 110, and a second node (e.g. its drain node) coupled to the reference level. The reference level is equivalently a variable power supply voltage which changes between a low level VL and a high level VH and can be controlled by the controller 205. The low level VL for example (but not limited) is the ground level, and the high level VH for example (but not limited) is the supply voltage level VDD. In one embodiment (but not limited), the first node of specific transistor QN is directly coupled to the transfer gate switch transistor SW_{TG}; however, this is not intended to be a limitation of the invention. In addition, it should be noted that, in this embodiment, the specific transistor QN has the operation and function of a source follower transistor and also has the operation and function of charge discharging.

For the operation, before the voltage at the first floating diffusion node FD is transferred into the second floating diffusion node FDv, the reference level is switched into the low level VL so that the voltage at the second floating diffusion node FDv decreased down a lower level due to the low level VL. Then, when the voltage at the first floating diffusion node FD is transferred into the second floating diffusion node FDv, the reference level is switched back to the high level VH so that the voltage at the second floating diffusion node FDv can follow and is almost equivalently to the voltage at the first floating diffusion node FD.

The transfer gate switch transistor SW_{TG} is controlled by a control signal S_SWTG sent from the controller 205 and it has a control node coupled to the control signal S_SWTG, a first node coupled to the first floating diffusion node FD (or the reference level changing between the levels VH/VL) through the specific transistor QN, and a second node coupled to the second floating diffusion node FDv. The second floating diffusion node FDv is to be read by the readout circuit 115. The reset storage circuit 1101R, coupled between the second floating diffusion node FDv and the ground level, comprises a reset switch transistor SW_{RST} (which is controlled by a control signal S_SWRST sent from the controller 205) and a reset storage capacitor C_{RST} which are connected in series. The signal storage circuit 1101S, coupled between the second floating diffusion node FDv and the ground level, comprises a signal switch transistor SW_{SIG} (which is controlled by a control signal S_SWSIG sent from the controller 205) and a signal storage capacitor C_{SIG} which are connected in series.

The transistor Q1 has a control node coupled to the second floating diffusion node FDv, a first node coupled to the supply voltage level VDD, and a second node coupled to the transistor Q2. The transistor Q2 has a control node coupled to a control signal RS (i.e. a row select control signal) sent from the controller 205, a first node coupled to the transistor Q1, and a second node used to output the read charge signal(s).

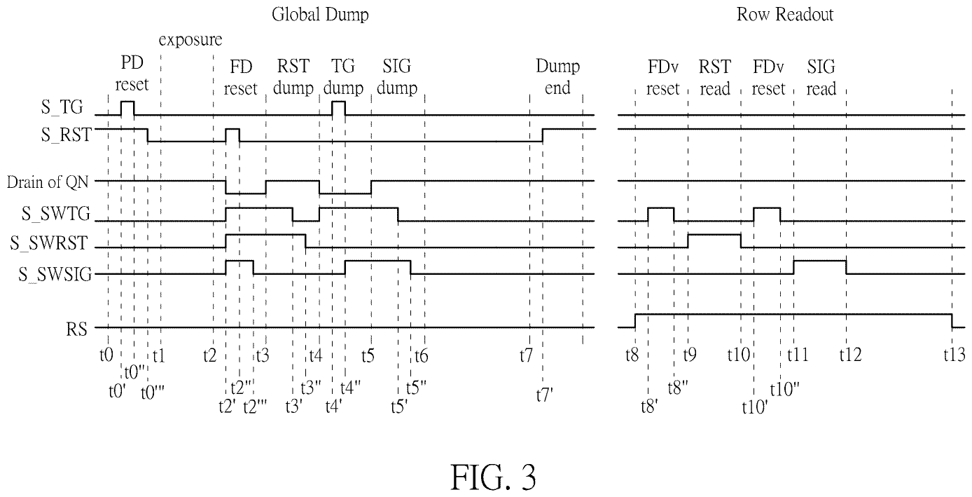

FIG. 3 is a diagram showing the waveforms of the corresponding control signals and the dump operation (e.g. global dump) and readout operation (e.g. row readout) of the image sensor circuit 100 as shown in FIG. 1 according to an embodiment of the invention. As shown in FIG. 3, initially, during the photodiode's PD reset period from t0 to t1, when the reset transistor RST is turned on by the signal S_RST having the high level during the time from t0 to t0′″, the transfer gate transistor TG is turned on and then turned off by the signal S_TG having a high level defined by a rising edge at t0′ and a following falling edge at t0″, so as to reset the state of the photodiode PD before performing the light exposure operation. In this situation, the level (i.e. the reference level) at the drain of specific transistor QN is at the high level VH such as the supply voltage level VDD, and the other control signals S_SWTG, SW_SWRST, SWSIG, RS are at the low level such as the ground level.

During the light exposure period from t1 to t2, the control signals S_TG and S_RST are at the low level, and the transfer gate transistor TG and reset transistor RST are turned-off, so that the photodiode PD receives and accumulate electron-hole pairs which are proportional to the light intensity.

During the floating diffusion node's FD (or FDv) reset period from t2 to t3, when a rising edge occurs in the control signal S_RST to turn on the reset transistor RST at t2′, the reference level at the drain of specific transistor QN is switched from the high level VH into the low level VL, and simultaneously all the control signals S_SWTG, S_SWRST, S_SWSIG have rising edges to turn on the transfer gate switch transistor SW_{TG}, reset switch transistor SW_{RST}, and signal switch transistor SW_{SIG}, so that the states (i.e. residual charges) of the floating diffusion nodes FD and FDv can be reset, e.g. a voltage level at the second floating diffusion node FDv is reset. In this situation, the voltage at second floating diffusion node FDv can be discharged through the turned-on transfer gate switch transistor SW_{TG} and specific transistor QN into the low level VL. The reset transistor RST is turned off at t2″, and then the signal switch transistor SW_{SIG} is turned off at t2′″. The reset switch transistor SW_{RST} is still turned on to be ready for the reset charge signal's dump period.

During the reset charge signal's dump period from t3 to t4, the transfer gate transistor TG is turned-off by the signal S_TG having the low level, the reset transistor RST is turned-off by the signal S_RST having the low level, the reference level at the drain of specific transistor QN is switched from the low level VL into the high level VH at t3 and switched back to the low level VL at t4, and the signal switch transistor SW_{SIG} is turned-off by the signal S_SWSIG having the low level. In this situation, the transfer gate switch transistor SW_{TG} is at the turned-on state before t3′ and is switched from the turned-on state into the turned-off state at t3′ by the falling edge of the control signal S_SWTG, and the reset switch transistor SW_{RST} is at the turned-on state before t3″ and is switched from the turned-on state into the turned-off state at t3″ by the falling edge of the control signal S_SWRST, so that the voltage level at the second floating diffusion node FDv is increased in response to a reset charge signal buffered at the first floating diffusion node FD when the reference level changes from the low level VL into the high level VH at t3. The voltage level at the second floating diffusion node FDv is increased to store the reset charge signal buffered at the first floating diffusion node FD into the reset storage capacitor when the reference level changes from the low level VL into the high level VH. Thus, the reset charge signal can be transferred from the first floating diffusion node FD into the second floating diffusion node FDv and then is dumped into and stored by the reset storage capacitor C_{RST}.

During the transfer gate dump period from t4 to t5, the reference level at the drain of specific transistor QN is switch from the high level VH into the low level at t4 and switched back into the high level VH at t5, the reset transistor RST is at the turn-off state since the control signal S_RST is at the low level, and the reset switch transistor SW_{RST} is also at the turn-off state since the control signal S_SWRST is at the low level. In this situation, the transfer gate transistor TG is turned on at the t4′ and then turned off at t4″ by the rising edge and following falling edge of control signal S_TG, so that the charge signal stored in the photodiode PD is transferred into the first floating diffusion node FD through the transfer gate transistor TG during the time from t4′ to t4″. Since the transfer gate switch transistor SW_{TG} and signal switch transistor SW_{SIG} are simultaneously turned on by the rising edges of control signals S_SWTG and S_SWSIG at t4″ which is later than t4′ and t4, and thus during the time from t4 to t4″ the voltage at the second floating diffusion node FDv can be discharged (or reset) again.

Then, during the charge signal's dump period from t5 to t6, the reference level at the drain of specific transistor QN is immediately switched from the low level VL into the high level VH at t5, the transfer gate switch transistor SW_{TG} is at the turned-on state based on the high level of control signal S_SWTG during the time from t5 to t5′, and the signal switch transistor SW_{SIG} is at the turned-on state based on the high level of control signal S_SWSIG during the time from t5 to t5″. At t4, the reference level changes from the high level VH into the low level VL, the voltage level at the second floating diffusion node FDv is reset, and then the voltage level at the second floating diffusion node FDv is increased to store a signal charge signal buffered at the first floating diffusion node FD into the signal storage capacitor C_{SIG} when the reference level changes from the low level VL into the high level VH at t5. Thus, the charge signal buffered in the first floating diffusion node FD can be transferred and dumped into the second floating diffusion node FD (which follows the voltage at the first floating diffusion node FD) and then stored by the signal storage capacitor C_{SIG}. Finally, at t7′, the reset transistor RST is turned on by the rising edge of control signal S_RST, and the global dump operation is finished.

For the row readout operation during the time from t8 to t13, the row select transistor Q2, controlled by the control signal RS, is at the turned-on state, the transfer gate transistor TG is turned off by the control signal S_TG having the low level, the reset transistor RST is turned on by the control signal S_RST having the high level, and the reference level at the drain of specific transistor QN is kept at the high level and is not changed. In this situation, during the second floating diffusion node's FDv reset period from t8 to t9, the transfer gate switch transistor SW_{TG} is turned on by the control signal S_SWTG having the high level during the time from t8′ to t8″ while the signal switch transistor SW_{SIG} and reset switch transistor SW_{RST} are turned off, so that the level at second floating diffusion node FDv is reset through the turned-on reset transistor RST and the specific transistor QN.

Then, during the reset charge signal's readout period from t9 to t10, the reset switch transistor SW_{RST} are turned on by the control signal S_SWRST having the high level while the transfer gate switch transistor SW_{TG} and signal switch transistor SW_{SIG} are turned off, so that the reset charge signal buffered in the reset storage capacitor C_{RST} can be transferred and read out through the turned-on reset switch transistor SW_{RST}, turned-on transistor Q1 (used as a source follower), and the turned-on transistor Q2.

Then, similarly, during the second floating diffusion node's FDv reset period from t10 to t11, the transfer gate switch transistor SW_{TG} is turned on by the control signal S_SWTG having the high level during the time from t10′ to t10″ while the signal switch transistor SW_{SIG} and reset switch transistor SW_{RST} are turned off, so that the level at second floating diffusion node FDv is reset again through the turned-on reset transistor RST and the specific transistor QN.

Similarly, during the charge signal's readout period from t11 to t12, the signal switch transistor SW_{SIG} are turned on by the control signal S_SWRST having the high level while the transfer gate switch transistor SW_{TG} and signal switch transistor SW_{SIG} are turned off, so that the charge signal buffered in the signal storage capacitor C_{SIG} can be transferred and read out through the turned-on signal switch transistor SW_{SIG}, turned-on transistor Q1 (used as a source follower), and the turned-on transistor Q2.

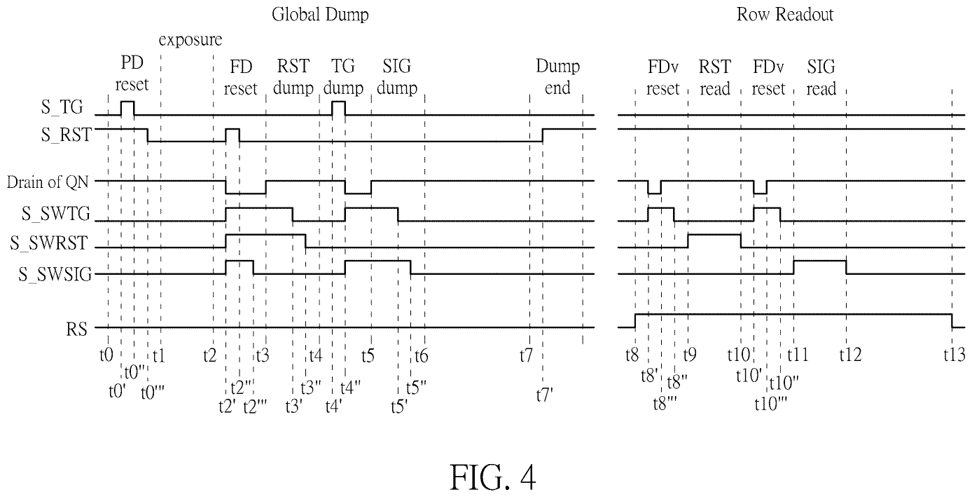

FIG. 4 is a diagram showing the waveforms of the corresponding control signals and the dump operation (e.g. global dump) and readout operation (e.g. row readout) of the image sensor circuit 100 as shown in FIG. 1 according to another different embodiment of the invention. As shown in FIG. 4, the difference compared to FIG. 3 is that the reference level at the drain of specific transistor QN during the transfer gate dump period from t4 to t5 is switched from the high level VH into the low level VL at t4″ which is later than t4. In addition, in FIG. 4, the reference level at the drain of specific transistor QN during the second floating diffusion node's FDv reset period from t8 to t9 is switched from the high level VH into the low level VL at t8′ and then switched back into the high level VH at t8′″. When the transfer gate switch transistor SW_{TG} is turned-on and the reset switch transistor SW_{RST} is turned-off, the reference level changes from the high level VH into the low level VL at t8′ to reset the voltage level at the second floating diffusion node FDv, and then when the transfer gate switch transistor SW_{TG} is turned-off and the reset switch transistor SW_{RST} is turned-on, the reference level changes from the low level VL into the high level VH at t8″′ is at the high level at t9 to make a reset charge signal buffered in the reset storage capacitor C_{RST} be read out by the readout circuit 115 of the image sensor circuit 100.

Similarly, the reference level at the drain of specific transistor QN during the second floating diffusion node's FDv reset period from t10 to t11 is switched from the high level VH into the low level VL at t10′ and then switched back into the high level VH at t10′″. when the transfer gate switch transistor SW_{TG} is turned-on and the signal switch transistor SW_{SIG} is turned-off, the reference level changes from the high level VH into the low level VL at t10′ to reset the voltage level at the second floating diffusion node FDv, and then when the transfer gate switch transistor SW_{TG} is turned-off at t10″ and the signal switch transistor SW_{SIG} is turned-on at t11, the reference level changes from the low level VL into the high level VH at t10″′ and is at the high level VH at t11 to make a signal charge signal buffered in the signal storage capacitor C_{SIG} be read out by the readout circuit 115 of the image sensor circuit 100.

This voltage switching of the reference level is used to reset or discharge the voltage at the second floating diffusion node FDv before the charge signal (or reset charge signal) is read out. In addition, this can avoid that the voltage at the first floating diffusion node FD becomes over high and leads to a current leakage at the first floating diffusion node FD. By switching the reference level between the high level VH and low level VL appropriately, this can avoid the current leakage or mitigate the issue.

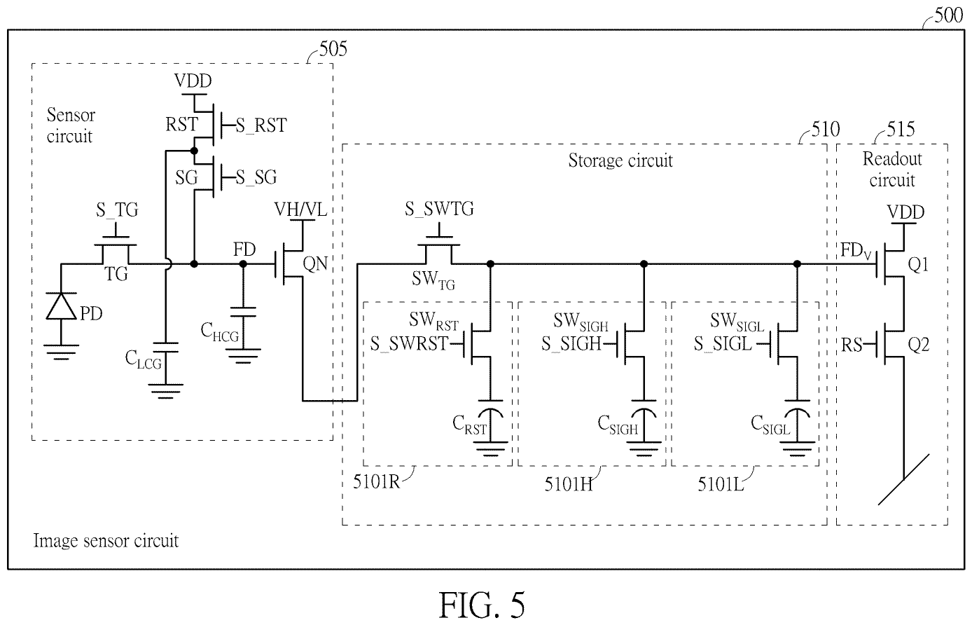

FIG. 5 is a diagram of an image sensor circuit 500 according to another embodiment of the invention. The image sensor circuit 500 comprises a sensor circuit 505, a storage circuit 510, and a readout circuit 515. The sensor circuit 505 comprises the photodiode PD, the first floating diffusion node FD, the transfer gate transistor TG, the reset transistor RST, storage capacitors C_{LCG} and C_{HCG}, a switch gate transistor SG (which is controlled by the signal S_SG), and the specific transistor QN. The storage capacitor C_{HCG} is used to indicate an inherent capacitance of the circuit structure of the sensor circuit 505, and the storage capacitor C_{LCG} is a configured specific charge capacitor which is disposed between the ground level and an intermediate node which is between the reset transistor RST and switch gate transistor SG that is disposed and coupled between the reset transistor RST and first floating diffusion node FD. The capacitance of storage capacitor C_{LCG} is several times more than the inherent capacitance C_{HCG}, and the storage capacitor C_{LCG} is used as a larger capacitor to receive and store the charge which overflows from the photodiode PD to the first floating diffusion node FD if the photodiode PD becomes full during the light exposure under some brighter conditions, so that more charges can be stored and thus this provides the high dynamic range for the signal charges.

The storage circuit 510 comprises the transfer gate switch transistor SW_{TG}, the second floating diffusion node FDv, two signal storage circuits 5101L and 5101H, and the reset storage circuit 5101R. The readout circuit 515 comprises the first readout transistor Q1 and second readout transistor Q2. The operations and functions of image sensor circuit 500 are similar to those of image sensor circuit 100. A difference is that the image sensor circuit 500 uses two signal storage circuits 5101L and 5101H to provide the high dynamic range to store the different charges (i.e. different charge signals). The capacitance of capacitor C_{SIGL} comprised by the storage circuit 5101L is greater than that of capacitor C_{SIGH} comprised by the storage circuit 5101H.

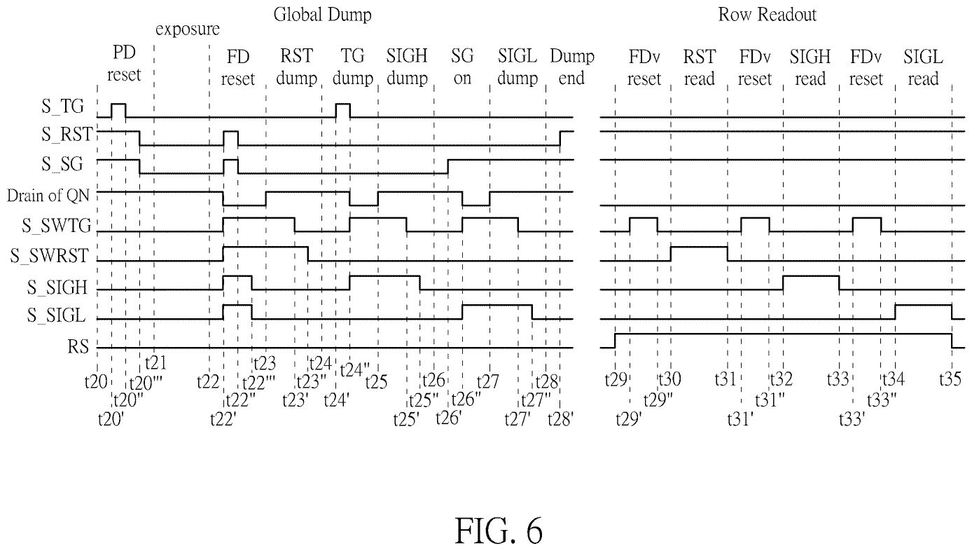

FIG. 6 is a diagram showing the waveforms of the corresponding control signals and the dump operation (e.g. global dump) and readout operation (e.g. row readout) of the image sensor circuit 500 as shown in FIG. 5 according to an embodiment of the invention. The dump operation (e.g. global dump) and readout operation (e.g. row readout) of the image sensor circuit 500 are similar to the image sensor circuit's 100 dump and readout operations as shown in FIG. 3. The differences are detailed in the following.

During the photodiode's PD reset period from t20 to t21, when the reset transistor RST is turned on by the signal S_RST having the high level during the time from t20 to t20′″, the switch gate transistor SG is also turned on by the signal S_SG having the high level so that the photodiode PD can be reset.

During the floating diffusion node's FD (or FDv) reset period from t22 to t23, when the rising edge occurs in the control signal S_RST and S_SG to turn on the reset transistor RST and switch gate transistor SG at t22′, the reference level at the drain of specific transistor QN is switched from the high level VH into the low level VL, and simultaneously all the control signals S_SWTG, S_SWRST, S_SIGH, S_SIGL have rising edges to turn on the transfer gate switch transistor SW_{TG}, reset switch transistor SW_{RST}, and switch transistors SW_{SIGH} and SW_{SIGL}, so that the states (i.e. residual charges) of the floating diffusion nodes FD and FDv can be reset. In this situation, the voltage at second floating diffusion node FDv can be discharged through the turned-on transfer gate switch transistor SW_{TG} and specific transistor QN into the low level VL. The reset transistor RST and switch gate transistor SG are turned off at t22′, and then the switch transistors SW_{SIGH} and SW_{SIGL} is turned off at t22′″.

During the reset charge signal's dump period from t23 to t24, the reference level at the drain of specific transistor QN is switched from the low level VL into the high level VH at t23, the switch transistors SW_{SIGH} and SW_{SIGL} are turned-off by the signal S_SIGH and S_SIGL having the low level, the transfer gate switch transistor SW_{TG} is at the turned-on state before t23′ and is switched from the turned-on state into the turned-off state at t23′ by the falling edge of the control signal S_SWTG, and the reset switch transistor SW_{RST} is at the turned-on state before t23″ and is switched from the turned-on state into the turned-off state at t23″ by the falling edge of the control signal S_SWRST, so that the reset charge signal can be transferred from the first floating diffusion node FD into the second floating diffusion node FDv and then is dumped into and stored by the reset storage capacitor C_{RST}.

During the transfer gate dump period from t24 to t25, the transfer gate transistor TG is turned on at t24′ and then is turned off at t24″ by the rising edge and subsequent falling edge of control signal S_TG, the reference level at the drain of specific transistor QN before t24″ is at the high level VH and then is switched into the low level VL at t24″, the transfer gate switch transistor SW_{TG} is turned on at t24″ by the rising edge of control signal S_SWTG, and the signal switch transistor SW_{SIGH} is also turned on by the rising edge of control signal S_SIGH at t24″; in this situation, the signal switch transistor SW_{SIGL} is turned off. During the first charge signal's dump period from t25 to t26, the reference level at the drain of specific transistor QN is kept at the high level VH, the transfer gate switch transistor SW_{TG} is turned off by the falling edge of control signal S_SWTG at t25′, and then the signal switch transistor SW_{SIGH} is turned off by the falling edge of control signal S_SIGH at t25″. By doing so, a first charge signal (i.e. a first portion of signal charges) can be transferred and dumped into the first floating diffusion node FD from the photodiode PD during the time from t24″ to t25′ and then can be dumped into the second floating diffusion node FDv during the time from t24″ to t25″.

During the period from t26 to t27, the switch gate transistor SG is turned on by the rising edge of control signal S_SG at t26′ and the control signal S_SG may be kept at the high level VH, the reference level at the drain of specific transistor QN before t26″ is at the high level VH and is switched into the low level VL at t26″ and then switched back to the high level VH at t27, the transfer gate switch transistor SW_{TG} is turned on at t26″ by the rising edge of control signal S_SWTG, and the signal switch transistor SW_{SIGL} is also turned on by the rising edge of control signal S_SIGH at t24″; in this situation, the signal switch transistor SW_{SIGH} is turned off. During the second charge signal's dump period from t27 to t28, the reference level at the drain of specific transistor QN is kept at the high level VH, the transfer gate switch transistor SW_{TG} is turned off by the falling edge of control signal S_SWTG at t27′, and then the signal switch transistor SW_{SIGL} is turned off by the falling edge of control signal S_SIGH at t27″. By doing so, a second charge signal (i.e. a second portion of signal charges) can be transferred and dumped into the first floating diffusion node FD from the capacitor C_{LCG} during the time from t26″ to t27′ and then can be dumped into the second floating diffusion node FDv during the time from t26″ to t27″. Finally, at t28′, the reset transistor RST is turned on by the rising edge of control signal S_RST, and the global dump operation is finished.

For the row readout operation during the time from t29 to t35, the row select transistor Q2, controlled by the control signal RS, is at the turned-on state, the transfer gate transistor TG is turned off by the control signal S_TG having the low level, the reset transistor RST and switch gate transistor SG are turned on by the control signals S_RST and S_SG having the high level, and the reference level at the drain of specific transistor QN may be kept at the low level VL and is not changed. Similarly, the transfer gate switch transistor SW_{TG} is turned on during the time from t29′ to t29″ while the signal switch transistors SW_{SIGH}, SW_{SIGL} and reset switch transistor SW_{RST} are turned off, so that the level at second floating diffusion node FDv can be reset or discharged. Then, the reset switch transistor SW_{RST} are turned on during the time from t30 to t31 while the transfer gate switch transistor SW_{TG} and signal switch transistors SW_{SIGH} and SW_{SIGL} are turned off, so that the reset charge signal buffered in the reset storage capacitor C_{RST} can be transferred and read out through the turned-on reset switch transistor SW_{RST}, turned-on transistor Q1 (used as a source follower), and the turned-on transistor Q2. Then, the transfer gate switch transistor SW_{TG} is turned on again during the time from t31′ to t31″ while the signal switch transistors SW_{SIGH}, SW_{SIGL} and reset switch transistor SW_{RST} are turned off, so that the level at second floating diffusion node FDv can be reset or discharged again. Then, the signal switch transistor SW_{SIGH} is turned on during the time from t32 to t33 while the transfer gate switch transistor SW_{TG}, signal switch transistor SW_{SIGL}, and reset switch transistor SW_{RST} are turned off, so that the buffered first charge signal can be transferred and read out. Then, the transfer gate switch transistor SW_{TG} is turned on again during the time from t33′ to t33″ while the signal switch transistors SW_{SIGH}, SW_{SIGL} and reset switch transistor SW_{RST} are turned off, so that the level at second floating diffusion node FDv can be reset or discharged again. Then, the signal switch transistor SW_{SIGL} is turned on during the time from t34 to t35 while the transfer gate switch transistor SW_{TG}, signal switch transistor SW_{SIGH}, and reset switch transistor SW_{RST} are turned off, so that the buffered second charge signal can be transferred and read out. Finally, at t35, the row readout operation is finished.

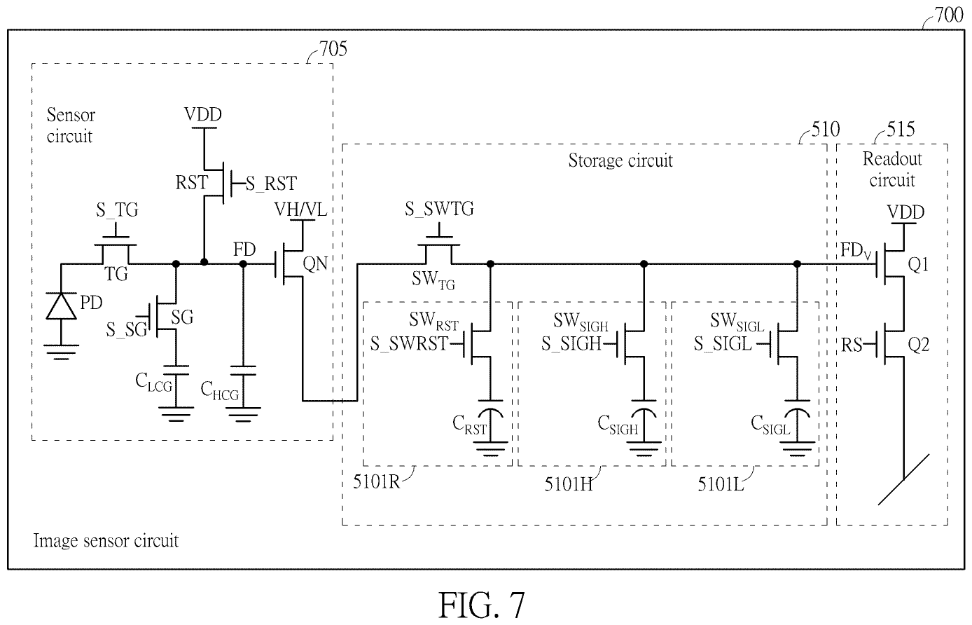

In other embodiments, the switch gate transistor SG can be disposed in a different position of the sensor circuit, and thus the operations of switch gate transistor SG and reset transistor RST can be performed individually and separately. FIG. 7 is a diagram of an image sensor circuit 700 according to another embodiment of the invention. The image sensor circuit 700 comprises a sensor circuit 705, the storage circuit 510, and the readout circuit 515. The operations and functions of storage circuit 510 and readout circuit 515 in FIG. 7 are identical to those of storage circuit 510 and readout circuit 515 in FIG. 5. A difference between the embodiments of FIG. 5 and FIG. 7 is that the storage capacitor C_{LCG} in FIG. 7 is a configured capacitor which is disposed between the ground level and the first floating diffusion node FD through the specific switch gate transistor SG which is disposed between the first floating diffusion node FD and the storage capacitor C_{LCG}. Also, the capacitance of storage capacitor C_{LCG} is several times more than the inherent capacitance C_{HCG}, and the storage capacitor C_{LCG} is used as a larger capacitor to receive and store the charge which overflows from the photodiode PD to the first floating diffusion node FD if the photodiode PD becomes full during the light exposure under some brighter conditions, so that more charges can be stored and thus this provides the high dynamic range for the signal charges. By doing so, the image sensor circuit 700 can also provide the high dynamic range to store the different charges (i.e. different charge signals).

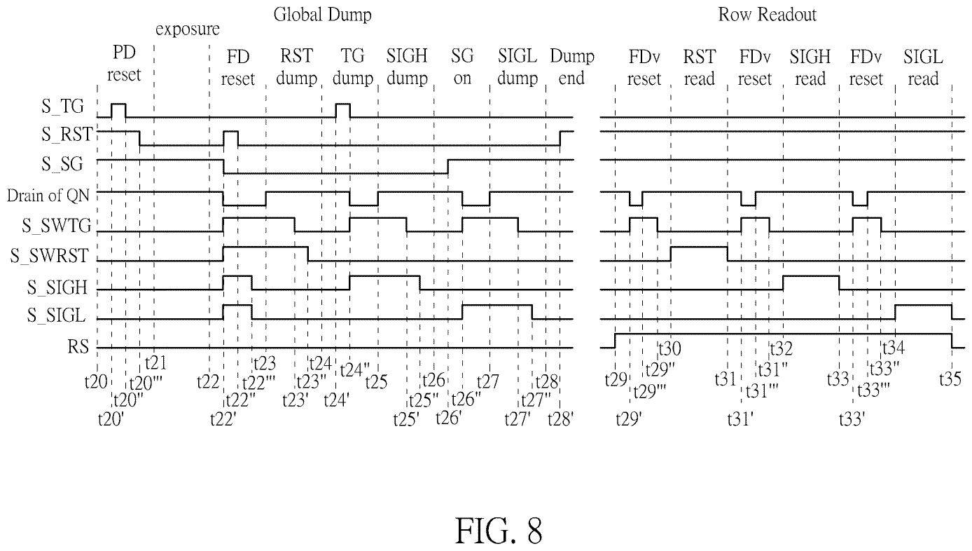

FIG. 8 is a diagram showing the waveforms of the corresponding control signals and the dump operation (e.g. global dump) and readout operation (e.g. row readout) of the image sensor circuit 700 as shown in FIG. 7 according to another embodiment of the invention. The dump operation (e.g. global dump) and readout operation (e.g. row readout) of the image sensor circuit 700 are similar to the image sensor circuit's 100 dump and readout operations as shown in FIG. 3. The differences are detailed in the following.

During the photodiode's PD reset period from t20 to t21 and the light exposure time period from t21 to t22, the switch gate transistor SG is turned on by the signal S_SG having the high level and is turned off by the falling edge of the control signal S_SG at t22, so that the photodiode PD can be reset and then the storage capacitor C_{LCG} is used as a larger capacitor to receive and store the charge which overflows from the photodiode PD to the first floating diffusion node FD if the photodiode PD becomes full during the light exposure under some brighter conditions; thus, more charges can be stored and thus this provides the high dynamic range for the signal charges.

Further, during the row readout operation as shown in FIG. 8, the reference level at the drain of specific transistor QN can be instantly switched from the high level VH into the low level VL at a time point (e.g. t29′, 231′, and t33′) during the floating diffusion node's reset period and then switched back to the high level VH at a next time point (e.g. t29′, 231′, and t33′). Similarly, this voltage switching of the reference level is used to reset or discharge the voltage at the second floating diffusion node FDv before the charge signal (or reset charge signal) is read out. In addition, this can avoid that the voltage at the first floating diffusion node FD becomes over high and leads to a current leakage at the first floating diffusion node FD. This can avoid the current leakage or mitigate the issue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A storage circuit of an image sensor circuit, the storage circuit being disposed between a sensor circuit of the image sensor circuit and a readout circuit of the image sensor circuit, and the storage circuit comprises:
a transfer gate switch transistor, having a first node coupled to a first floating diffusion node and a second node coupled to a second floating diffusion node;
the second floating diffusion node, to be read by the readout circuit;
a signal storage circuit, coupled between the second floating diffusion node and a ground level; and
a reset storage circuit, coupled between the second floating diffusion node and the ground level;
wherein the reference level changes between a low level and a high level; when the reference level changes from the high level into the low level, a voltage level at the second floating diffusion node is reset, and then the voltage level at the second floating diffusion node is increased in response to a charge signal at the first floating diffusion node when the reference level changes from the low level into the high level.

2. The storage circuit of claim 1, wherein the low level is a ground level, and the high level is a supply voltage level.

3. The storage circuit of claim 1, wherein the reset storage circuit comprises a reset switch transistor and a reset storage capacitor which are connected in series; when the transfer gate switch transistor and the reset switch transistor are turned-on and the reference level changes from the high level into the low level, the voltage level at the second floating diffusion node is reset to reset the reset storage capacitor, and then the voltage level at the second floating diffusion node is increased to store a reset charge signal buffered at the first floating diffusion node into the reset storage capacitor when the reference level changes from the low level into the high level.

4. The storage circuit of claim 1, wherein the signal storage circuit comprises a signal switch transistor and a signal storage capacitor which are connected in series; when the transfer gate switch transistor and the signal switch transistor are turned-on and the reference level changes from the high level into the low level, the voltage level at the second floating diffusion node is reset to reset the signal storage capacitor, and then the voltage level at the second floating diffusion node is increased to store a signal charge signal buffered at the first floating diffusion node into the signal storage capacitor when the reference level changes from the low level into the high level.

5. The storage circuit of claim 1, wherein the transfer gate switch transistor's the first node is directly coupled to a first node of a specific transistor of the sensor circuit, and the specific transistor has a second node coupled to the reference level which changes between the high level and the low level and has a control node coupled to the first floating diffusion node.

6. The storage circuit of claim 1, wherein the reset storage circuit comprises a reset switch transistor and a reset storage capacitor which are connected in series; when the transfer gate switch transistor is turned-on and the reset switch transistor is turned-on, the reference level changes from the high level into the low level to reset the voltage level at the second floating diffusion node, and then when the transfer gate switch transistor is turned-off and the reset switch transistor is turned-on, the reference level changes from the low level into the high level to make a reset charge signal buffered in the reset storage capacitor be read out by the readout circuit of the image sensor circuit.

7. The storage circuit of claim 1, wherein the signal storage circuit comprises a signal switch transistor and a signal storage capacitor which are connected in series; when the transfer gate switch transistor is turned-on and the signal switch transistor is turned-off, the reference level changes from the high level into the low level to reset the voltage level at the second floating diffusion node, and then when the transfer gate switch transistor is turned-off and the signal switch transistor is turned-on, the reference level changes from the low level into the high level to make a signal charge signal buffered in the signal storage capacitor be read out by the readout circuit of the image sensor circuit.

8. The storage circuit of claim 1, further comprising:
another storage circuit, coupled between the second floating diffusion node and the ground level;
wherein the signal storage circuit is used for storing a first charge signal by using a first storage capacitor while the another signal storage circuit is used for storing a second charge signal by using a second storage capacitor which has a capacitance that is greater than a capacitance of the first storage capacitor.

9. An image sensor circuit, comprising:
the storage circuit of claim 1;
a sensor circuit, coupled to the storage circuit, comprising:
a photodiode;
the first floating diffusion node;
a transfer gate transistor, couple between the photodiode and the first floating diffusion node;
a reset transistor, coupled between the first floating diffusion node and a supply voltage level; and
a specific transistor, having a first node coupled to the first node of the transfer gate switch transistor of the storage circuit, a second node coupled to the reference level, and a control node coupled to the first floating diffusion node.

10. The image sensor circuit of claim 9, wherein the sensor circuit further comprises:
a switch gate transistor, having a first node coupled to the first floating diffusion node, a second node coupled to the reset transistor which is coupled between the supply voltage level and the switch gate transistor; and
a specific charge capacitor, coupled between the ground level and the second node of the switch gate transistor;
wherein a portion of a signal charge signal at the first floating diffusion node is buffered into the specific charge capacitor when the reset transistor is turned off and the switch gate transistor is turned on.

11. The image sensor circuit of claim 9, wherein the sensor circuit further comprises:
a switch gate transistor, having a first node coupled to the first floating diffusion node, a second node coupled to a specific charge capacitor; and
the specific charge capacitor, coupled between the ground level and the second node of the switch gate transistor;
wherein a portion of a signal charge signal at the first floating diffusion node is buffered into the specific charge capacitor when the switch gate transistor is turned on.

12. A method of an image sensor circuit, the image sensor circuit's storage circuit being disposed between a sensor circuit of the image sensor circuit and a readout circuit of the image sensor circuit, and the method comprises:
providing a transfer gate switch transistor, having a first node coupled to a first floating diffusion node and a second node coupled to a second floating diffusion node;
providing the second floating diffusion node, to be read by the readout circuit;
providing a signal storage circuit, coupled between the second floating diffusion node and a ground level;
providing a reset storage circuit, coupled between the second floating diffusion node and the ground level;
changing the reference level between a low level and a high level;
when the reference level changes from the high level into the low level, resetting a voltage level at the second floating diffusion node; and
increasing the voltage level at the second floating diffusion node in response to a charge signal at the first floating diffusion node when the reference level changes from the low level into the high level.

13. The method of claim 12, wherein the low level is a ground level, and the high level is a supply voltage level.

14. The method of claim 12, wherein the reset storage circuit comprises a reset switch transistor and a reset storage capacitor which are connected in series, and the method further comprises:
when the transfer gate switch transistor and the reset switch transistor are turned-on and the reference level changes from the high level into the low level, resetting the voltage level at the second floating diffusion node to reset the reset storage capacitor; and
increasing the voltage level at the second floating diffusion node to store a reset charge signal buffered at the first floating diffusion node into the reset storage capacitor when the reference level changes from the low level into the high level.

15. The method of claim 12, wherein the signal storage circuit comprises a signal switch transistor and a signal storage capacitor which are connected in series, and the method further comprises:
when the transfer gate switch transistor and the signal switch transistor are turned-on and the reference level changes from the high level into the low level, resetting the voltage level at the second floating diffusion node to reset the signal storage capacitor; and
increasing the voltage level at the second floating diffusion node to store a signal charge signal buffered at the first floating diffusion node into the signal storage capacitor when the reference level changes from the low level into the high level.

16. The method of claim 12, wherein the reset storage circuit comprises a reset switch transistor and a reset storage capacitor which are connected in series, and the method further comprises:
when the transfer gate switch transistor is turned-on and the reset switch transistor is turned-off, changing the reference level from the high level into the low level to reset the voltage level at the second floating diffusion node; and
when the transfer gate switch transistor is turned-off and the reset switch transistor is turned-on, changing the reference level from the low level into the high level to make a reset charge signal buffered in the reset storage capacitor be read out by the readout circuit of the image sensor circuit.

17. The method of claim 12, wherein the signal storage circuit comprises a signal switch transistor and a signal storage capacitor which are connected in series, and the method further comprises:
when the transfer gate switch transistor is turned-on and the signal switch transistor is turned-off, changing the reference level from the high level into the low level to reset the voltage level at the second floating diffusion node; and
when the transfer gate switch transistor is turned-off and the signal switch transistor is turned-on, changing the reference level from the low level into the high level to make a signal charge signal buffered in the signal storage capacitor be read out by the readout circuit of the image sensor circuit.
